(19) United States
(12) Patent Application Publication
(10) Pub. No.: US 2016/0028226 A1
(43) Pub. Date: Jan. 28, 2016

(54) MODULAR SURGE PROTECTION DEVICE WITH STATUS INDICATOR

(71) Applicant: Michael Kuo, Las Vegas, NV (US)

(72) Inventor: Michael Kuo, Las Vegas, NV (US)

(21) Appl. No.: 14/338,353

(22) Filed: Jul. 23, 2014

(51) Int. Cl. H02H 9/04

(52) U.S. Cl. CPC H02H 9/044

(57) ABSTRACT

A modular surge protection device provides surge protection for various electronic devices while including one or more status indicators that make the modular surge protection device's status or condition readily ascertainable to save time during inspection, maintenance, replacement and other activities. The modular surge protection device comprises a nipple that can be used to mount the modular surge protection device to various structures quickly and easily. In addition, the nipple includes a view port for viewing or otherwise reading information from one or more status indicators positioned within the nipple.

### BACKGROUND OF THE INVENTION

1. Field of the Invention

The invention relates to surge protection devices and in particular to a modular surge protection device with one or more status indicators.

2. Related Art

Traditional surge protection devices protect against electrical surges that can damage or destroy electronic equipment. There are various types of surge protection devices. Perhaps the most familiar is a residential type surge protector that is plugged into a wall outlet. Electronic equipment can then be powered and protected by the surge protector by plugging such equipment into the surge protector. This residential type of surge protector is directly accessible by users and can be replaced, when desired or necessary, by disconnecting the surge protector and replacing it with a functional unit.

In contrast to the above-described traditional consumer type of surge protection devices, surge protection devices in commercial, industrial, professional or “heavy duty” applications, are often built in to electronic equipment making replacement activity difficult.

In addition, due to age, one or more surges, defects or other factors a surge protection device's ability to protect electronic equipment may be diminish or fail completely over time. However, a surge protection device may continue to provide power to electronic equipment connected thereto. This is highly undesirable since the electronic equipment, though powered, is exposed to damaging and destructive surges.

From the discussion that follows, it will become apparent that the present invention addresses the deficiencies associated with the prior art while providing numerous additional advantages and benefits not contemplated or possible with prior art constructions.

### SUMMARY OF THE INVENTION

Various modular surge protection devices and methods therefore are disclosed herein. The modular surge protection device may be a self-contained unit providing surge protection as well as an indication of its operating status or condition. The modular surge protection device advantageously provides its status in a readily ascertainable manner while remaining compatible with various housings, enclosures, and other structures to which the modular surge protection device may be mounted. In this manner, inspection, maintenance, repair, replacement and other activity is made more efficient in terms of time and cost.

A modular surge protection device may be implemented in a variety of ways. In one embodiment for example, a modular surge protection device comprises a body comprising a polygonal peripheral shape and an enclosed front end and an enclosed back end, a surge protection element housed within the body, and a threaded nipple extending outward from the enclosed front end of the body and comprising a view port at its distal end. The polygonal peripheral shape aids in turning the surge protection device and its threaded nipple during installation and removal.

One or more status indicators are within the threaded nipple and visible through the view port. The status indicators are operably coupled to the surge protection element to present a status of the surge protection element. The status indicators may be light emitting devices, and the status of the surge protection element may comprise a normal condition and a fault condition.

It is noted that the status indicators may be at a proximal end of the threaded nipple. In addition, a plurality of indentations, a plurality of slots, or both may be at an exterior side of the enclosed back end. The plurality of indentations, slots or both may be provided to aid in turning the surge protection device and its threaded nipple during installation and removal.

In another exemplary embodiment, a modular surge protection device comprises a body comprising an enclosed front end and an enclosed back end, a surge protection element housed within the body, and a nipple extending outward from the enclosed front end of the body. The nipple comprises an enclosed proximal end and a view port at its distal end. The body may have a polygonal peripheral shape to aid in installation or removal of the surge protection device.

One or more status indicators are housed within the nipple and operatively connected to the surge protection element to present a status of the surge protection element. The status indicators are visible through the view port. The status indicators may be at the proximal end of the nipple. In addition, the status indicators may be light emitting devices.

It is noted that the nipple may be threaded, and that the surge protection device may be mounted via its nipple. In addition, the surge protection may include one or more indentations, one or more slots, or both at an exterior surface of the enclosed back end of the body to aid in installation or removal of the surge protection device.

As stated various methods related to the modular surge protection device are disclosed herein as well. In one exemplary embodiment, a method for providing surge protection and an indication of status implemented with a surge protection device comprises receiving input power at a surge protection element housed within a body of the surge protection device, providing output power through the surge protection element, securing the body to an opening of an external structure with a nipple extending outward from an enclosed front end of the body, and activating one or more status indicators housed within the nipple to present a status of the surge protection element. During operation, one or more surges of the input power are dissipated via the surge protection element.

The status indicators are visible through a view port at a distal end of the nipple. The nipple may secure the body to the opening of the external structure with one or more threads on an exterior surface of the nipple. Also, the nipple may extend outward from the external structure when securing the body to the opening of the external structure. This allows the status of the surge protection element to be ascertained remote to and outside of the external structure.

The status of the surge protection element may be determined by a fault detector in operable communication with the surge protection element and the status indicators. Activation of the status indicators may occur by activating or deactivating light emission at the status indicators.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a back perspective view illustrating an exemplary modular surge protection device;

FIG. 2 is a front perspective view illustrating an exemplary modular surge protection device;

FIG. 3 is a front view illustrating an exemplary modular surge protection device;

FIG. 4 is a side view illustrating an exemplary modular surge protection device in an exemplary utility box;

FIG. 5 is a block diagram illustrating an exemplary modular surge protection device;

FIG. 6 is a block diagram illustrating an exemplary surge protection element;

FIG. 7 is a block diagram illustrating an exemplary modular surge protection device connected to an electronic device;

FIG. 8 is a block diagram illustrating an exemplary modular surge protection device connected to an electronic device;

FIG. 9 is a block diagram illustrating an exemplary modular surge protection device connected to an electronic device; and

FIG. 10 illustrates an exemplary environment of use for an exemplary modular surge protection device.

### DETAILED DESCRIPTION OF THE PREFERRED EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

The modular surge protection device with status indicator (hereinafter “modular surge protection device”) disclosed herein allows users, maintenance personnel or others to quickly and easily identify a status condition of the modular surge protection device. Appropriate action can then be taken if necessary, such as replacing or repairing the modular surge protection device.

The modular surge protection device is ideally suited for environments of use where surge protection is desirable and where electronic devices or elements thereof that are being protected are in difficult to reach, inconvenient, concealed or enclosed areas. For example, the modular surge protection device may be used on utility poles, or within electrical enclosures/boxes or utility boxes to provide a status condition quickly and conveniently. It is noted that the self-contained nature (i.e., modularity) of the modular surge protection device allows it to be used in other environments as well.

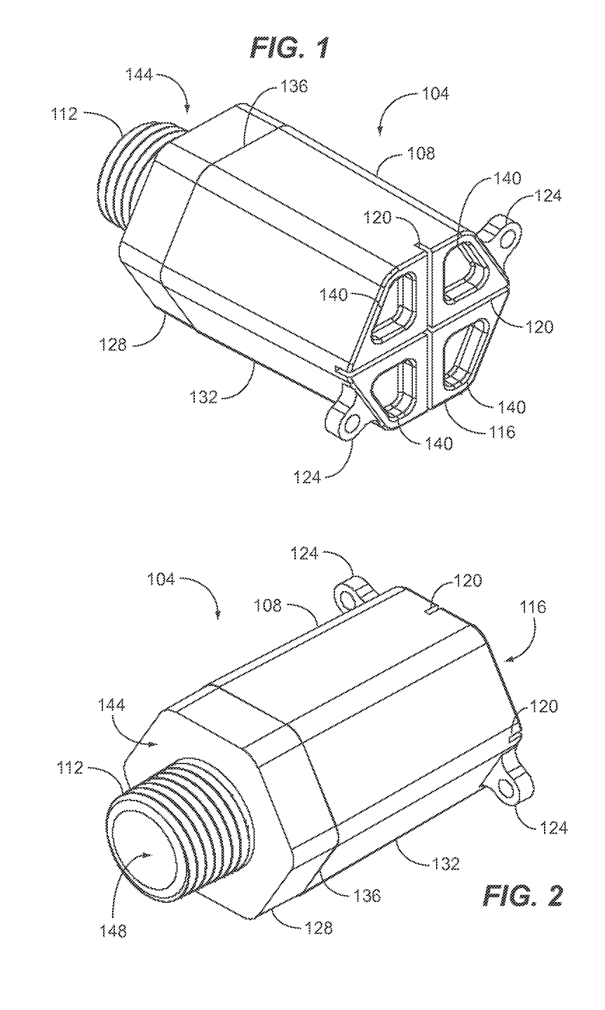

FIGS. 1-2 respectively illustrate a back perspective view and a front perspective view of an exemplary modular surge protection device 104. As can be seen, the modular surge protection device may comprise a body 108, a nipple 112 at its front end 144, and a back end 116. The body 108 forms a housing to enclose the internal components of the modular surge protection device 104. The body 108 may be enclosed at the front end 144 and back end 116, or both to prevent infiltration of humidity, water, dirt, debris or other unwanted contaminants.

The body 108 may comprise one or more separate portions 128, 132, as shown by the line 136, that are attached together during assembly. Such portions 128, 132 may be secured to one another in various ways. For example, corresponding male and female threaded structures may be provided to allow the portions 128, 132 to be secured to one another in a screw type fashion. Alternatively, the portions 128, 132 may be adhered together. In addition, the portions 128, 132 may be secured together with one or more fasteners, such as screws, pins or the like. The portions 128, 132 may also be secured by a snap fit or friction fit connection formed by connecting structures of each of the portions. It is noted that the portions 128, 132 may remain separable in some embodiments, such as to allow access to the internal components of the modular surge protection device 104 for repair, replacement, diagnostic or other purposes. Alternatively, the body 108 may be a single integrated structure.

It is contemplate that the body 108 may various shapes. As shown in the embodiment of FIGS. 1-2 for example, the body 108 is hexagonal. This assists in grasping and turning the modular surge protection device 104, such as during its installation or removal. To further aid in the installation or removal process, one or more indentations 140 may be at a back end 116 of the modular surge protection device 116. These indentations 140 provide grasping points for a turning tool, such as pliers. In addition, one or more slots 120 may be provided to accept a turning tool, such as a cross or flat headed screwdriver.

The nipple 112 will typically be threaded, such as shown in FIGS. 1-2. This is advantageous in that the front end 144 of the modular surge protection device 104 may be mounted by screwing or turning the nipple 112 into a threaded opening, such as in a utility box or other structure. The nipple 112 may have an opening or view port 148 through which a visual or other status indicator may be viewed or accessed.

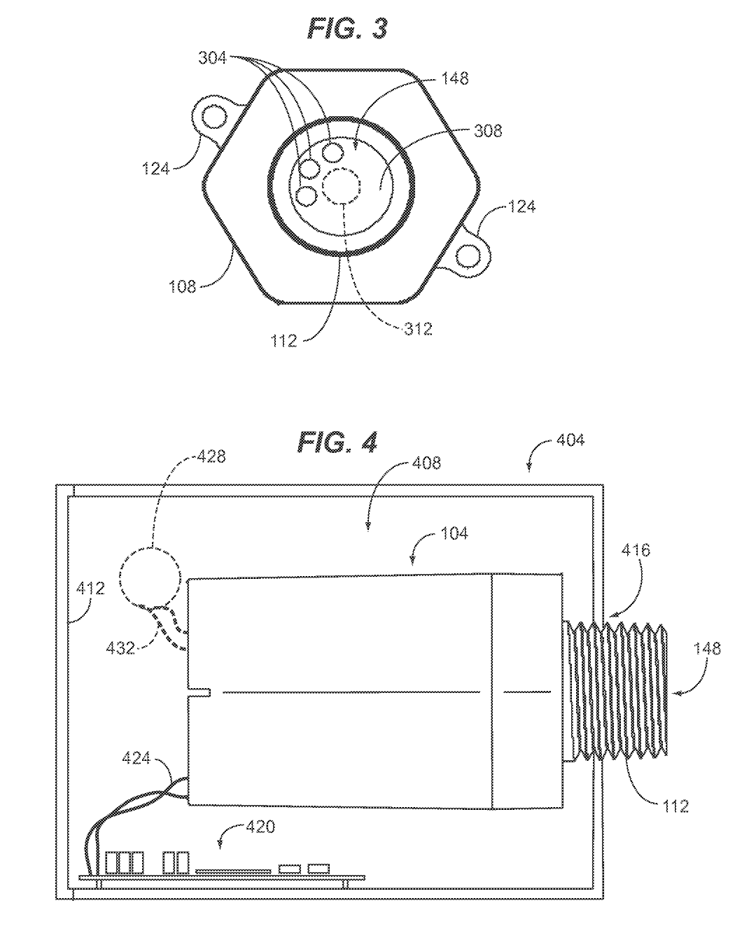

With the modular surge protection device 104 herein, the nipple 112 also forms an enclosure for a status indicator of the modular surge protection device. Referring to FIG. 3, which illustrates a front view of a modular surge protection device 104, it can be seen that one or more status indicators 304 may be viewed through the view port 148 of the modular surge protection device's nipple 112. This permits a quick inspection and determination of the status or operating condition of the modular surge protection device 104. A status indicator 304 will typically be an indicator light, such as an LED light, but other indicators may be used as well. It is contemplated that status indication may occur via color, illumination versus non-illumination, blinking of a status indicator or multiple status indicators, or various combinations thereof.

The exemplary embodiment of FIG. 3 includes three status indicators 304. Some exemplary statuses are disclosed in the following table.

TABLE 1

| | SURGE PROTECTION |
|---|---|
| INDICATED | DEVICE CONDITION |
| 1 Status Indicator Activated | Functioning Normally |
| 2 Status Indicators Activated | Surge Occurred/Damaged |
| | Replacement Required |
| 3 Status Indicators Activated | Unknown Condition |

It will be understood that a variety of status conditions may be presented by one or more status indicators 304. In addition a single status indicator 304 may present various status conditions by through different colors, activation or non-activation, and blinking at one or more rates. As such, there may be fewer (or additional) status indicators 304 than the exemplary amount shown in FIG. 3. It is noted that a status indicator 304 may emit various output, including infrared, ultraviolet, radio, microwave or other electromagnetic. In some embodiments, a status indicator 304 may be a speaker or other audio output device as well.

In some embodiments, a status indicator 304 may comprise or consist of an on/off or logic switch or signal-generating device that generates an on/off or logic signal. Such switches or signals may be used to activate or deactivate an output generating device to present the status or condition of a modular surge protection device or one or more components thereof.

Users or other personnel may be supplied with detection equipment including various sensors, such as to detect signals from status indicators 304 utilizing invisible, inaudible or other unperceivable output. This detection equipment may then report the detected status to a user or other personnel via a screen, indicator, speaker or other human interface device.

A status indicator 304 may be mounted or secured to the bottom 308 of the nipple 112 in one or more embodiments. Alternatively, a status indicator 304 may be mounted or secured to a sidewall of the nipple 112 as well. Typically the bottom 308 will be a continuous structure to enclose or seal the components of a modular surge protection device 104 within the body 108 of the modular surge protection device. This helps ensure such components are protected from contaminants, debris or moisture. In some embodiments, an opening 312 or knock out to form an opening may optionally be provided if desired. Such opening 312 may be used to allow electrical or other cable to connect to a component of the modular surge protection device. It is contemplated that one or more additional status indicators may be connected to the modular surge protection device 104 through the opening 312 if desired.

FIG. 4 illustrates a modular surge protection device 104 installed in an exemplary utility box 404. As can be seen, the utility box 404 provides a compartment 408 that may contain one or more electrical devices 420 powered by a connection 424 with the modular surge protection device 104. Alternatively, the utility box 404 may simply house the modular surge protection device 104 and nothing else. A removable section 412, or knock out or opening 428 in the utility box 404 may be provided to allow an electrical connection 432 between the modular surge protection device 104 and a power source, such as an electrical outlet, one or more electrical devices 420 or both. In addition to the circuit board illustrated in FIG. 4, some exemplary electrical devices 420 that may be powered by the modular surge protection device 104 include LED lights or lighting, motors, controllers.

As described above, the modular surge protection device 104 may be mounted via its nipple 112. This is illustrated in FIG. 4, which illustrates a modular surge protection device 104 screwed into a threaded opening 416 of the utility box 404. It is noted that the modular surge protection device 104 may be quickly and easily mounted in this manner to various structures comprising a compatible threaded opening 416. Thereafter the modular surge protection device 104 may be removed by reversing the nipple 112 out of the threaded opening 416 in which it was secured.

In one or more embodiments the nipple 112 may be sized and/or comprise threads that conform to standard utility box 404 or other enclosure threaded or other openings. For example, a nipple 112 may conform to the NPT or NEC standard in some embodiments. This is advantageous in that it allows the modular surge protection device 104 to be mounted to a variety of utility boxes 404. This allows the modular surge protection device 104 to be used in a wide variety of installations. In addition, the status indicator 304 of the modular surge protection device 104 is accordingly easily visible without opening a utility box 404 or other enclosure, saving time and expense during maintenance or inspection activity.

Preferably, the modular surge protection device 104 is mounted such that its view port 148 is readily visible. In the example of FIG. 4 for example, the view port 148 is visible from an exterior point of view relative to the utility box 404. This is advantageous in that the status or condition of the modular surge protection device 104 can then be readily ascertained simply by visually inspecting the status indicators through the modular surge protection device's view port 148. Such inspection can even occur at remote distances thereby increasing the speed and efficiency at which the status or condition of a modular surge protection device 104 can be determined. Thereafter appropriate personnel can decide whether or not to repair or replace only the modular surge protection devices 104 that have indicated a need for the same via its status indicator(s).

It is contemplated that, in some embodiments, a status indicator of the modular surge protection device 104 may indicate a status or condition of one or more electronic devices 420 that are connected thereto. In this manner, the modular surge protection device 104 can also inform appropriate personnel that an electronic device 420 should be repaired or replaced or of the need thereof.

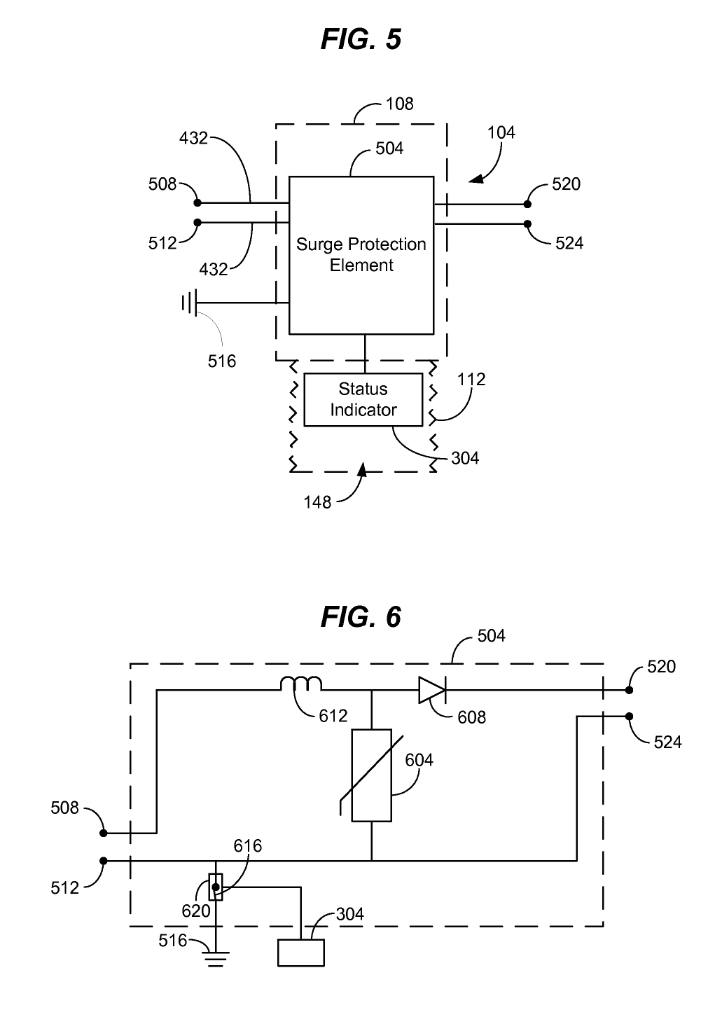

FIG. 5 provides a block diagram of an exemplary modular surge protection device 104. As can be seen, one or more surge protection elements or surge protection circuitry 504 may be within the body 108 of the modular surge protection device 104, while one or more status indicators 304 are within the nipple 112 of the modular surge protection device. As described above, a status indicator 304 will typically be visible, such as via a view port 148 of the nipple 112. Electrical power may be received at the surge protection circuitry 504 via one or more terminals 508, 512, 516. In one or more embodiments, a first of the terminals 516 may be connected to ground while the remaining terminals 508, 512 may respectively be a live and neutral connection. One or more output terminals 520, 524 provide an interface or connection point where an electronic device may be connected to and receive power from the modular surge protection device 104.

FIG. 6 is a block diagram illustrating components of an exemplary surge protection element 504. It is contemplated that a variety of surge protection circuitry, devices or the like, now known or later developed, may be used in the modular surge protection device 104 as its surge protection element 504. In addition, one or more surge protection elements 504 may be provided to protect an electronic device from electrical surges.

As can be seen, a surge protection element 504 may comprise a first and second input terminals 508, 512 to respectively receive a line and neutral connection, and output terminals 520, 524 for connecting to an electronic device. It is noted that a modular surge protection device may accept AC or DC input/signals of various levels, such as be configuring or installing a surge protection element capable of handling such input/signals.

The surge protection element 504 may also comprise one or more fuses 616, inductors 612, metal oxide varistors (MOVs) 604, and diodes 608. A fault detector 620 will typically also be included. As can be seen, the fault detector 620 may provide input to a status indicator 304, which in turn indicates the condition or status of the surge protection element 504, as described above.

In normal operation, power flows from the input terminals 508, 512 to the output terminals 520, 524. The inductor 612 of FIG. 6 allows the power to flow to the output terminal 520 substantially unimpeded. A diode 608 may be provided to prevent power from flowing from the output terminal 520 back to the surge protection element's components.

During a surge condition, additional circuit elements may be activated. For example, a MOV 604 may accept power levels beyond a particular threshold and dissipate such surge voltage via a ground terminal 516. A fault detector 620 may be in series between the ground terminal and a MOV 604. In this manner, a surge that disables or damages the MOV 604 can be detected or inferred by examining the voltage or current level through the fault detector 620. Upon detecting a voltage or current level beyond its predefined threshold, the fault detector 620 may signal a status indicator 304 to activate or directly activate a status indicator, such as by diverting/transmitting power to the status indicator.

In some embodiments, a fault detector 620 may comprise a switch 616 held in a closed position by solder. The solder melts and releases the switch when a surge sufficient to damage or destroy a MOV 604 passes through the fault detector 620. Once the solder melts, the switch 616 may automatically release through a spring or other biasing mechanism. When the switch 616 is open, the status indicator 304 may be activate to indicate a failure condition notifying a user or other personnel that the modular surge protection device is no longer able to dissipate a surge. It is noted that multiple MOVs 604 may be present within a modular surge protection device and that a status indicator 304 may indicate a failure condition when a plurality of the MOVs are disabled or destroyed. In this manner, the modular surge protection device can withstand a number of substantial surges before replacement or repair action must be taken.

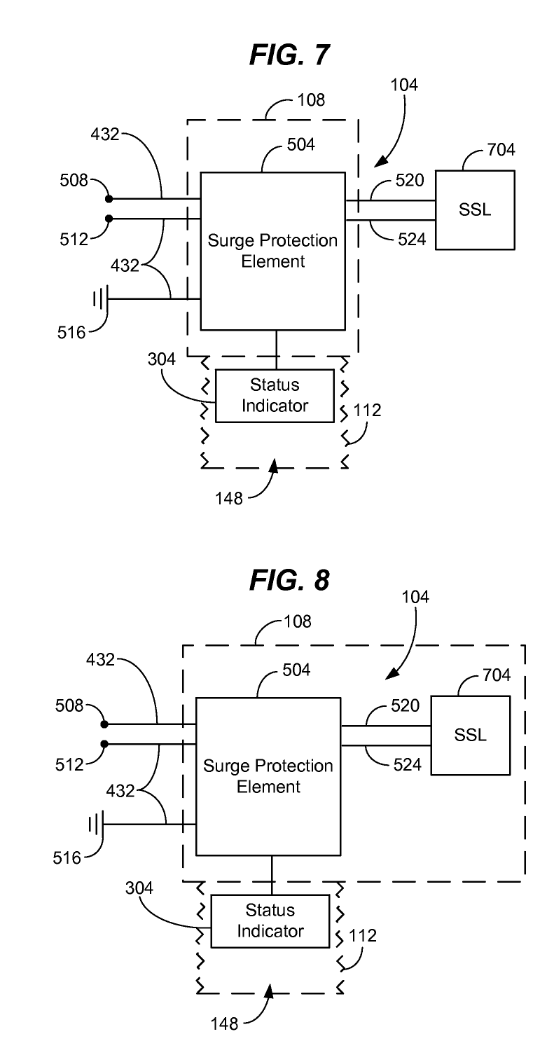

FIG. 7 illustrates an exemplary modular surge protection device 104 connected to solid state lighting 704. As can be seen, the solid state lighting 704 may be connected to one or more output terminals 520, 524 of the modular surge protection device 104. The solid state lighting 704 may comprise one or more LEDs for example. It is noted that a modular surge protection device 104 may be connected to various electronic devices to provide power thereto.

In operation, the surge protection element 504 protects the solid state lighting 704 from power surges, while the status indicator 304 presents the status or condition of the modular surge protection device 104. Should a component of the modular surge protection device 104, such as its surge protection element 504, become damaged, destroyed or be operating in an abnormal condition, the status indicator 304 may change from a first state to one or more second states to indicate the same. As described above, this may occur by activating or deactivating one or more indicators of the status indicator 304.

FIG. 8 illustrates an exemplary modular surge protection device 104, also connected to solid state lighting 704. In this exemplary embodiment, the modular surge protection device 104 comprises an enclosure 104, that also encloses the solid state lighting 704. It is noted that the enclosure 104 may have an opening or window to allow the solid state lighting 704 to emit light externally while inside the enclosure.

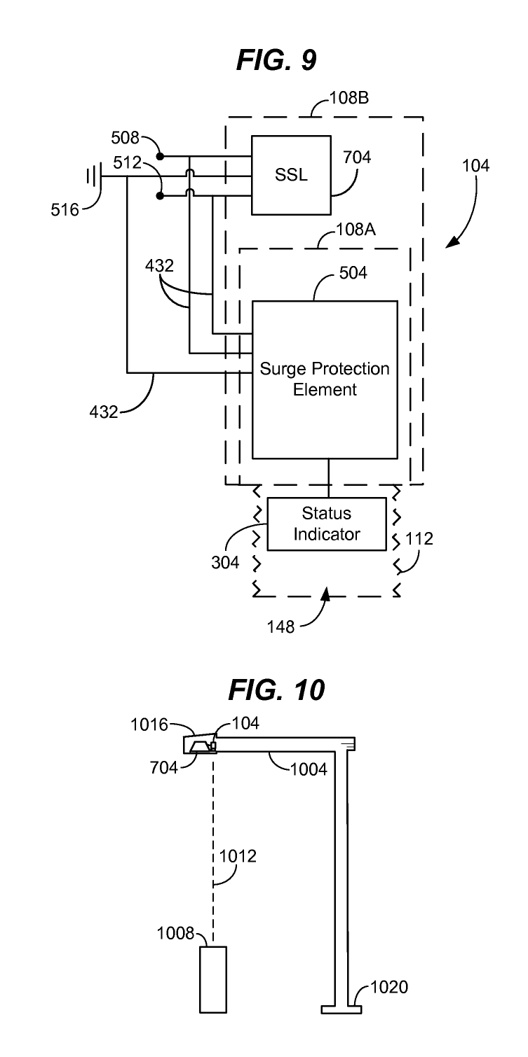

FIG. 9 illustrates an exemplary modular surge protection device 104 connected to solid state lighting 704 in a different manner. As can be seen, the surge protection element 504 and other electronic components may be independently connected to a power source via one or more input terminals 508, 512. Likewise, electronic components may have an independent ground terminal 516.

FIG. 9 also illustrates exemplary enclosures 108A, 108B that can be used with this circuit configuration. As can be seen, if provided, an enclosure 108A may house only the surge protection element 504. In an alternate embodiment, an enclosure 108B may house a surge protection element 504 along with one or more additional electronic components, such as solid state lighting 704.

As disclosed herein, the modular surge protection device 104 advantageously provides a nipple which both provides a mounting mechanism while also housing one or more status indicators. The modular surge protection device 104 can therefore be installed via its nipple in an opening of a utility box or other enclosure. Since the status indicator is visible via a view port of the modular surge protection device 104 the status or condition of the modular surge protection device is readily ascertained.

FIG. 10 illustrates an exemplary environment of use for a modular surge protection device 104. Namely, the modular surge protection device 104 is installed in the lamp housing 1016 of a street light 1004. As can be seen, the modular surge protection device 104 is connected to a fixture comprising solid state lighting 704. The modular surge protection device 104 protects the solid state lighting 704 from power surges in this manner, as described above.

The modular surge protection device 104 is installed such that an observer 1008 can ascertain the status of the modular surge protection device via a sight line 1012 (i.e., the nipple and view port are oriented such that they are visible from a convenient vantage point). As can be seen, in this example, the observer can easily determine the status of the modular surge protection device 104 from ground level. If repair, replacement or other action is not required based on the indicated status, the observer 1008 can move on right away, such as to inspect another street light 1004 and/or modular surge protection device 104.

It is noted that an observer 1008 may be a user or other personnel. Alternatively or in addition, an observer 1008 may comprise detection equipment, such as described above with regard to FIG. 3. Such detection equipment may be a portable or other device having one or more sensors that detect signals emitting from one or more status indicators of the modular surge protection device 104. Since the status indicator(s) of a modular surge protection device 104 are not blocked or occluded signal generation at a status indicator typically requires very little power.

It is noted that a status indicator may encode its signals such that only authorized users or personnel can determine the status of a modular surge protection device 104. For example, a status indicator may encrypt one or more signals it emits using public key or other encryption. A corresponding detection device, if authenticated/authorized, may then determine the status by decoding or decrypting the signals.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A surge protection device comprising:
a body comprising a polygonal peripheral shape and an enclosed front end and an enclosed back end;
a surge protection element housed within the body;
a threaded nipple extending outward from the enclosed front end of the body and comprising a view port at its distal end;
one or more status indicators within the threaded nipple and visible through the view port, wherein the one or more status indicators are operably coupled to the surge protection element to present a status of the surge protection element;
wherein the polygonal peripheral shape aids in turning the surge protection device and its threaded nipple during installation and removal.

2. The surge protection device of claim 1, wherein the one or more status indicators are at a proximal end of the threaded nipple.

3. The surge protection device of claim 1 further comprising a plurality of indentations on an exterior side of the enclosed back end, wherein the plurality of indentations aid in turning the surge protection device and its threaded nipple during installation and removal.

4. The surge protection device of claim 1 further comprising a plurality of slots on an exterior side of the enclosed back end, wherein the plurality of slots aid in turning the surge protection device and its threaded nipple during installation and removal.

5. The surge protection device of claim 1, wherein the polygonal shape is a hexagon.

6. The surge protection device of claim 1, wherein the one or more status indicators comprise light emitting devices or switches.

7. The surge protection device of claim 1, wherein the status of the surge protection element comprises a normal condition and a fault condition.

8. A surge protection device comprising:
a body comprising an enclosed front end and an enclosed back end;
a surge protection element housed within the body;
a nipple extending outward from the enclosed front end of the body, the nipple comprising an enclosed proximal end and a view port at its distal end;
one or more status indicators housed within the nipple and operatively connected to the surge protection element to present a status of the surge protection element, wherein the one or more status indicators are readable through the view port.

9. The surge protection device of claim 8, wherein the nipple is threaded.

10. The surge protection device of claim 8, wherein surge protection device is mounted via its nipple.

11. The surge protection device of claim 8, wherein the one or more status indicators are at the proximal end of the nipple.

12. The surge protection device of claim 8, wherein the one or more status indicators are light emitting devices.

13. The surge protection device of claim 8 further comprising one or more indentations, one or more slots, or both at an exterior surface of the enclosed back end of the body to aid in installation or removal of the surge protection device.

14. The surge protection device of claim 8, wherein the body has a polygonal peripheral shape to aid in installation or removal of the surge protection device.

15. A method for providing surge protection and an indication of status implemented with a surge protection device comprising:
receiving input power at a surge protection element housed within a body of the surge protection device;
providing output power through the surge protection element;
securing the body to an opening of an external structure with a nipple extending outward from an enclosed front end of the body;
activating one or more status indicators housed within the nipple to present a status of the surge protection element, wherein the one or more status indicators are readable through a view port at a distal end of the nipple.

16. The method of claim 15, wherein the nipple secures the body to the opening of the external structure with one or more threads on an exterior surface of the nipple.

17. The method of claim 15, wherein the nipple extends outward from the external structure when securing the body to the opening of the external structure.

18. The method of claim 15, wherein the status of the surge protection element is determined by a fault detector in operable communication with the surge protection element and the one or more status indicators.

19. The method of claim 15, wherein activating the one or more status indicators comprises activating or deactivating light emission or an on/off signal at the one or more status indicators.

20. The method of claim 15 further comprising dissipating one or more surges of the input power via the surge protection element.
